(19) United States
(12) Patent Application Publication
(10) Pub. No.: US 2024/0055880 A1
(43) Pub. Date: Feb. 15, 2024

(54) ELECTRONIC DEVICE

(71) Applicant: ASUSTEK COMPUTER INC., TAIPEI (TW)

(72) Inventor: Zuo-Jheng HUANG, Taipei (TW)

(21) Appl. No.: 18/159,819

(22) Filed: Jan. 26, 2023

(30) Foreign Application Priority Data
Aug. 12, 2022 (TW) 111130325

(51) Int. Cl. H02J 7/00

(52) U.S. Cl. CPC H02J 7/007; H02J 7/0045

(57) ABSTRACT

An electronic device including a connector, a charging management unit, a switch component, a first charging control unit, a second charging control unit, a multiplexer, and a control unit is provided. The connector has a configuration pin, a signal transmission pin, and a power transmission pin. The power transmission pin is electrically coupled to a battery through a charging path. The charging management unit and the switch component are disposed on the charging path. The first charging control unit supports a first charging protocol and is electrically coupled to the configuration pin. The second charging control unit supports a second charging protocol. The multiplexer is configured to selectively couple the signal transmission pin to an operating system or the second charging control unit. The control unit determines whether the charger supports the first charging protocol or not and controls the switch component and the multiplexer accordingly.

### CROSS-REFERENCE TO RELATED APPLICATION

This application claims the priority benefit of Taiwan application serial No. 111130325, filed on Aug. 12, 2022. The entirety of the above-mentioned patent application is hereby incorporated by reference herein and made a part of the specification.

### BACKGROUND OF THE INVENTION

### Field of the Invention

The disclosure relates to an electronic device, and in particular, to an electronic device connected to a charger and supporting a fast charging function.

### Description of the Related Art

At present, the popular fast charging protocols on the market are divided into a USB Power Delivery (USB PD) protocol made by USB Implementers Forum (USB-IF) and a Quick Charge (QC) protocol made by Qualcomm.

Because the two fast charging protocols have different charging standards, most of the portable electronic devices currently on the market only support one of the charging protocols. Using a notebook computer as an example, a conventional notebook computer supports only the USB PD protocol. Even if a charger that supports the QC protocol is used, the notebook computer fail to effectively use the maximum charging wattage supported by the charger to charge because it fails to identify the charger type.

### BRIEF SUMMARY OF THE INVENTION

The disclosure provides an electronic device. The electronic device includes an operating system, a battery, a connector, a charging management unit, a switch component, a first charging control unit, a second charging control unit, a multiplexer, and a control unit. The connector is electrically coupled to the operating system and the battery. The connector is adapted to be connected to a charger, and has a configuration pin, a signal transmission pin, and a power transmission pin. The power transmission pin is electrically coupled to the battery through a charging path. The charging management unit is disposed on the charging path, and configured to receive power from the charger through the connector and charge the battery.

The switch component is disposed on the charging path. The first charging control unit supports a first charging protocol, and is electrically coupled to the configuration pin. The second charging control unit supports a second charging protocol. The multiplexer is configured to selectively electrically couple the signal transmission pin to an operating system or the second charging control unit. The control unit is electrically coupled to the first charging control unit and the second charging control unit, determines whether the charger supports the first charging protocol or not by using the first charging control unit, and controls a conducting state of the switch component and a connection state of the multiplexer according to a determination result of whether the charger supports the first charging protocol or not.

The electronic device provided in the disclosure has the first charging control unit and the second charging control unit. The control unit determines whether the charger supports the first charging protocol or not by using the first charging control unit, and controls the multiplexer to electrically couple the second charging control unit to the charger when the charger does not support the first charging protocol. In this way, the charger supports two different fast charging protocols, such as a USB PD protocol and a QC protocol, and detects the charger type to select the ideal charging protocol.

### BRIEF DESCRIPTION OF THE DRAWINGS

FIG. 1 is a schematic block diagram of an electronic device according to an embodiment of the application; and

FIG. 2 is a schematic block diagram of an electronic device according to another embodiment of the application.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

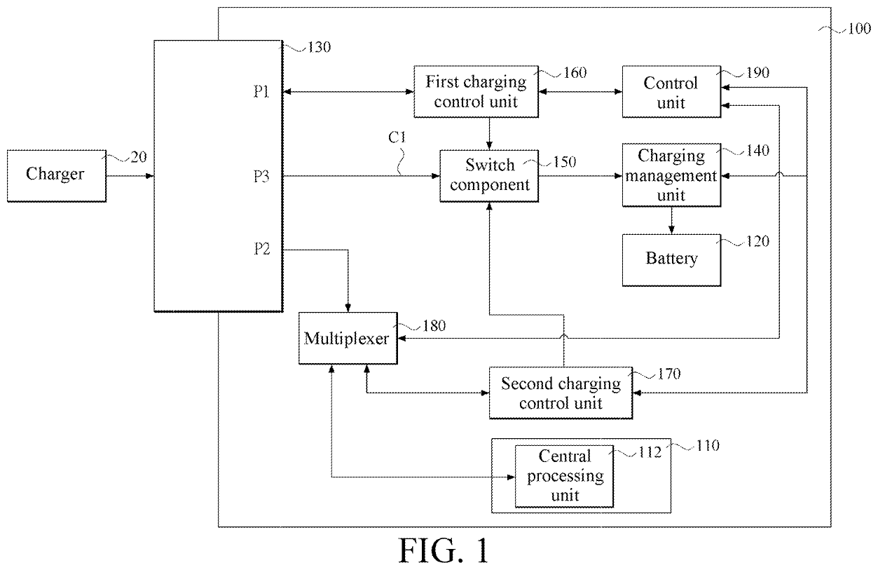

FIG. 1 is a schematic block diagram of an electronic device 100 according to an embodiment of the application.

The electronic device 100 includes an operating system 110, a battery 120, a connector 130, a charging management unit 140, a switch component 150, a first charging control unit 160, a second charging control unit 170, a multiplexer 180, and a control unit 190.

The operating system 110 has a central processing unit 112. The connector 130 is adapted to be connected to a charger 20, and has a configuration pin P1, a signal transmission pin P2, and a power transmission pin P3. In an embodiment, the connector 130 is a universal serial bus (USB) connector. Using a universal serial bus type-C connector as an example, its pins CC1 and CC2 are the configuration pins P1, its pins Dn1, Dp1, Dn2, and Dp2 are the signal transmission pins P2, and its pin VBUS is the power transmission pin P3. The power transmission pin P3 is electrically coupled to the battery 120 through a charging path C1.

The charging management unit 140 is disposed on the charging path C1, and configured to receive power from the charger 20 through the connector 130 and charge the battery 120. In an embodiment, the charging management unit 140 is a charging management chip.

The switch component 150 is disposed on the charging path C1. The first charging control unit 160 supports a first charging protocol, and is electrically coupled to the configuration pin P1. The second charging control unit 170 supports a second charging protocol.

In an embodiment, the first charging control unit 160 and the second charging control unit 170 are located on a same charging control chip. In some other embodiments, the first charging control unit 160 and the second charging control unit 170 are two independent charging control chips. The multiplexer 180 is configured to selectively electrically couple the signal transmission pin P2 to the operating system 110 or the second charging control unit 170.

The control unit 190 is electrically coupled to the first charging control unit 160 and the second charging control unit 170, determines whether the charger 20 supports the first charging protocol or not by using the first charging control unit 160, and controls a conducting state of the switch component 150 and a connection state of the multiplexer 180 according to a determination result of whether the charger supports the first charging protocol or not. In an embodiment, a preset state of the switch component 150 is an open circuit state, and the multiplexer 180 presets to electrically couple the signal transmission pin P2 to the operating system 110 for data transmission. In another embodiment, the control unit 190 is an embedded controller.

Specifically, when the control unit 190 determines that the charger 20 supports the first charging protocol by using the first charging control unit 160, the first charging control unit 160 obtains power supply specifications provided by the charger 20, requests the charger 20 to complete a voltage regulation action, and then notifies the control unit 190. After determining the power supply specifications of the charger 20, the control unit 190 sets relevant information to the charging management unit 140, and instructs the first charging control unit 160 to turn on the switch component 150, so that the power from the charger 20 is provided through the connector 130 and the charging path C1 to the charging management unit 140 to charge the battery 120. In some other embodiments, the control unit 190 is directly electrically coupled to the switch component 150 to control its conducting state, instead of controlling the switch component 150 by using the first charging control unit 160.

When the charger 20 does not support the first charging protocol, the control unit 190 controls the multiplexer 180 to electrically couple the signal transmission pin P2 to the second charging control unit 170, and determines whether the charger 20 supports the second charging protocol or not by using the second charging control unit 170.

When the control unit 190 determines that the charger 20 supports the second charging protocol by using the second charging control unit 170, the second charging control unit 170 obtains the power supply specifications provided by the charger 20, requests the charger 20 to complete a voltage regulation action, and then notifies the control unit 190. After determining the power supply specifications of the charger 20, the control unit 190 sets relevant information to the charging management unit 140, and instructs the second charging control unit 170 to turn on the switch component 150, so that the power from the charger 20 is provided through the connector 130 and the charging path C1 to the charging management unit 140 to charge the battery 120. In some other embodiments, the control unit 190 is directly electrically coupled to the switch component 150 to control its conducting state, instead of controlling the switch component 150 by using the second charging control unit 170.

When the charger 20 does not support the second charging protocol, the control unit 190 also instructs the second charging control unit 170 to turn on the switch component 150, and instructs the charging management unit 140 to charge according to a preset charging power of the connector 130.

In short, the electronic device 100 in the disclosure first determines whether the charger 20 supports the first charging protocol or not through the configuration pin P1, determines whether the charger 20 supports the second charging protocol or not through the signal transmission pin P2 if the charger 20 does not support the first charging protocol, and charges according to the preset charging power of the connector 130 if the charger 20 does not support the second charging protocol.

In an embodiment, a highest charging wattage of the first charging protocol is higher than a highest charging wattage of the second charging protocol, and the highest charging wattage of the second charging protocol is higher than the preset charging power of the connector 130. In an embodiment, the first charging protocol is a USB PD protocol, the second charging protocol is a QC protocol, and the preset charging power of the connector 130 is a preset charging power of a universal serial bus.

The electronic device 100 provided in the disclosure supports multiple fast charging protocols, such as the USB PD protocol and the QC protocol, and detects the charger 20 to select the ideal charging protocol, without additional operation of the user.

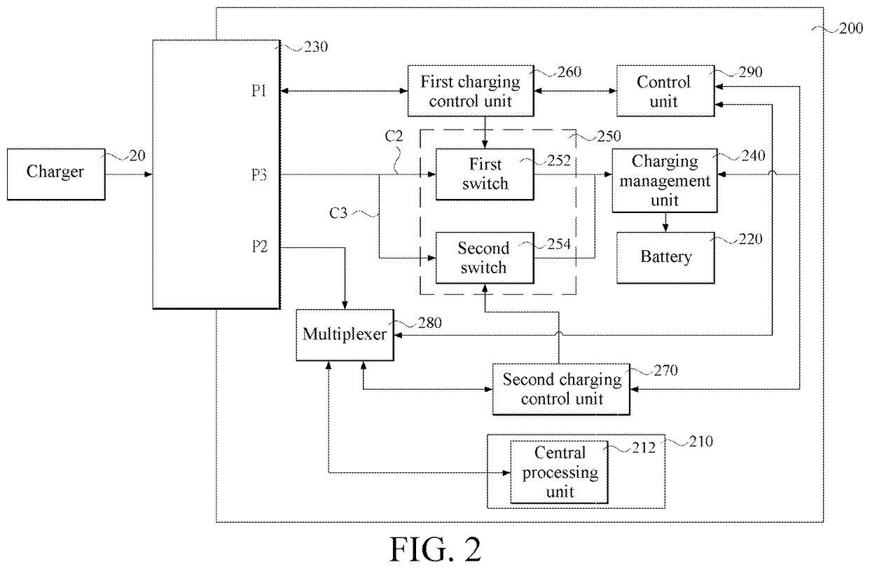

FIG. 2 is a schematic block diagram of an electronic device 200 according to another embodiment of the application.

Compared with the embodiment in FIG. 1, a switch component 250 in this embodiment includes a first switch 252 and a second switch 254. A power transmission pin P3 is electrically coupled to a charging management unit 240 through a first charging path C2 or a second charging path C3, and then electrically coupled to a battery 220 through the charging management unit 240. The first switch 252 is located on the first charging path C2, and the second switch 254 is located on the second charging path C3. The first charging path C2 and the second charging path C3 respectively correspond to a first charging protocol and a second charging protocol.

A first charging control unit 260 is electrically coupled to the first switch 252, and a control unit 290 controls a conducting state of the first switch 252 by using the first charging control unit 260, to control a conducting state of the first charging path C2. A second charging control unit 270 is electrically coupled to the second switch 254, and the control unit 290 controls a conducting state of the second switch 254 by using the second charging control unit 270, to control a conducting state of the second charging path C3.

Specifically, when the control unit 290 determines that the charger 20 supports the first charging protocol by using the first charging control unit 260, the first charging control unit 260 obtains power supply specifications provided by the charger 20, and requests the charger 20 to complete a voltage regulation action. After determining the power supply specifications of the charger 20, the control unit 290 sets relevant information to the charging management unit 240, and instructs the first charging control unit 260 to turn on the first switch 252, so that the power from the charger 20 is provided through the first charging path C2 to the charging management unit 240 to charge the battery 220. In some other embodiments, the control unit 290 is directly electrically coupled to the first switch 252 to control its conducting state, instead of controlling the first switch 252 by using the first charging control unit 260.

When the charger 20 does not support the first charging protocol, the control unit 290 controls a multiplexer 280 to switch from being electrically coupled to a central processing unit 212 of an operating system 210 to being electrically coupled to the second charging control unit 270, to electrically couple a signal transmission pin P2 to the second charging control unit 270, and determines whether the charger 20 supports the second charging protocol or not by using the second charging control unit 270.

When the control unit 290 determines that the charger 20 supports the second charging protocol by using the second charging control unit 270, the second charging control unit 270 obtains the power supply specifications provided by the charger 20, requests the charger 20 to complete a voltage regulation action, and then notifies the control unit 290. After determining the power supply specifications of the charger 20, the control unit 290 sets relevant information to the charging management unit 240, and instructs the second charging control unit 270 to turn on the second switch 254, so that the power from the charger 20 is provided through the second charging path C3 to the charging management unit 240 to charge the battery 220. In some other embodiments, the control unit 290 is directly electrically coupled to the second switch 254 to control its conducting state, instead of controlling the second switch 254 by using the second charging control unit 270.

When the charger 20 does not support the second charging protocol, the control unit 290 also instructs the second charging control unit 270 to turn on the second switch 254, and instructs the charging management unit 240 to charge according to a preset charging power of the connector 230.

The electronic device provided in the disclosure has the first charging control unit and the second charging control unit. The control unit determines whether the charger supports the first charging protocol or not by using the first charging control unit, and controls the multiplexer to electrically couple the second charging control unit to the charger when the charger does not support the first charging protocol. In this way, the charger supports two different fast charging protocols, such as a USB PD protocol and a QC protocol, and detects the charger type to select the ideal charging protocol.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An electronic device, comprising:
an operating system;
a battery;
a connector, electrically coupled to the operating system and the battery, wherein the connector is adapted to be connected to a charger, and has a configuration pin, a signal transmission pin, and a power transmission pin, and the power transmission pin is electrically coupled to the battery through a charging path;
a charging management unit, disposed on the charging path, and configured to receive power from the charger through the connector and charge the battery;
a switch component, disposed on the charging path;
a first charging control unit, supporting a first charging protocol, and electrically coupled to the configuration pin;
a second charging control unit, supporting a second charging protocol;
a multiplexer, configured to selectively electrically couple the signal transmission pin to the operating system or the second charging control unit; and
a control unit, electrically coupled to the first charging control unit and the second charging control unit, determining whether the charger supports the first charging protocol or not by using the first charging control unit, and controlling a conducting state of the switch component and a connection state of the multiplexer according to a determination result of whether the charger supports the first charging protocol or not.

2. The electronic device according to claim 1, wherein the switch component comprises a first switch and a second switch, the first switch is disposed on a first charging path, the second switch is disposed on a second charging path, and the first charging path and the second charging path respectively correspond to the first charging protocol and the second charging protocol.

3. The electronic device according to claim 2, wherein when the charger does not support the first charging protocol, the control unit controls the multiplexer to electrically couple the signal transmission pin to the second charging control unit, and turns on the second switch.

4. The electronic device according to claim 3, wherein the first charging control unit is electrically coupled to the first switch, and the control unit controls a conducting state of the first switch by using the first charging control unit.

5. The electronic device according to claim 4, wherein the second charging control unit is electrically coupled to the second switch, and the control unit controls a conducting state of the second switch by using the second charging control unit.

6. The electronic device according to claim 1, wherein when the charger does not support the first charging protocol, the control unit controls the multiplexer to electrically couple the signal transmission pin to the second charging control unit, and determines whether the charger supports the second charging protocol or not by using the second charging control unit.

7. The electronic device according to claim 6, wherein when the charger does not support the second charging protocol, the control unit instructs the charging management unit to charge according to a preset charging power of the connector.

8. The electronic device according to claim 1, wherein the first charging protocol is a USB PD protocol, and the second charging protocol is a QC protocol.

9. The electronic device according to claim 1, wherein the connector is a universal serial bus connector.

10. The electronic device according to claim 1, wherein the first charging control unit and the second charging control unit are located on a same charging control chip.

11. The electronic device according to claim 1, wherein the first charging control unit is a charging control chip.

12. The electronic device according to claim 1, wherein the control unit is an embedded controller.
